(19) United States
(12) Patent Application Publication
(10) Pub. No.: US 2012/0212135 A1
(43) Pub. Date: Aug. 23, 2012

(54) CONTROL APPARATUS, PLASMA PROCESSING APPARATUS, METHOD FOR CONTROLLING CONTROL APPARATUS

(75) Inventor: Keiji SUZUKI, Kanagawa-ken (JP)

(73) Assignee: KABUSHIKI KAISHA TOSHIBA, Tokyo (JP)

(21) Appl. No.: 13/349,793

(22) Filed: Jan. 13, 2012

(30) Foreign Application Priority Data
Feb. 23, 2011 (JP) 2011-037591

(51) Int. Cl. H05H 1/24

(52) U.S. Cl. 315/111.21

(57) ABSTRACT

According to one embodiment, a control apparatus configured to control a plasma processing apparatus including an electrode on which a substrate is disposed in a process room, a first power supply circuit, a plasma generation unit in the process room, a second power supply circuit, including a detection unit configured to detect parameters output from the first power supply circuit, and a control unit configured to control the first power and the second power supplied from the first power supply circuit and the second power supply circuit such that the parameters correspond to target values.

### CROSS REFERENCE TO RELATED APPLICATION

This application is based upon and claims the benefit of priority from prior Japanese Patent Application No. 2011-037591, filed on Feb. 23, 2011, the entire contents of which are incorporated herein by reference.

### FIELD

Exemplary embodiments described herein generally relate to a control apparatus, a plasma processing apparatus, and a method for controlling a control apparatus.

### BACKGROUND

In recent years, as a semiconductor device has been miniaturized, enhancement of processing accuracy has been required in processing technology on the semiconductor device.

In particular, an etching technique using a plasma processing apparatus such as reactive ion etching (RIE) apparatuses have a tendency that, even in the same model and under the same process conditions, variation in process dimensions or etching amount among different plasma processing apparatuses is at a significant level relative to the required process accuracy.

One of factors on the variation in process dimensions or etching amount among the processing apparatuses is variation in energy and flux of incident ions on a wafer. Generally, each of the plasma processing apparatuses execute processing steps while outputs of power supplies connected to an electrode on which a substrate to be processed is placed and an electrode to generate plasma are set for the respective electrodes.

In the processing steps, efficiency of power transmission from each power supply to the corresponding electrode might vary among the apparatuses due to a difference in assembly state or the like among these apparatuses.

When the same power is provided to each of chambers of the apparatuses through the electrodes with the same transmission efficiency, plasma density varies among the chambers due to different conditions in the chambers. Thus, the variation in ion energy and flux is generated in the apparatuses.

Accordingly, development of technique which decreases the difference of ion energy and flux between the apparatuses has been desired.

### BRIEF DESCRIPTION OF THE DRAWINGS

FIG. 1 is a schematic diagram showing a configuration of a plasma processing apparatus according to a first embodiment;

FIG. 2 is a schematic diagram showing another configuration of a plasma processing apparatus according to the first embodiment;

FIG. 3 is a flow chart showing actions of a control apparatus according to the first embodiment;

FIG. 4 is a flow chart showing other actions of the control apparatus according to the first embodiment;

FIG. 5 is a schematic diagram showing a configuration of a plasma processing apparatus according to a second embodiment;

FIG. 6 is a schematic diagram showing another configuration of a plasma processing apparatus according to the second embodiment;

FIG. 7 is a flow chart showing actions of a control apparatus according to the second embodiment;

FIG. 8 is a flow chart showing other actions of the control apparatus according to the second embodiment.

### DETAILED DESCRIPTION

According to one embodiment, a control apparatus configured to control a plasma processing apparatus, the plasma processing apparatus including an electrode on which a substrate to be processed is disposed in a process room, a first power supply circuit configured to supply first power to the electrode, a plasma generation unit configured to generate plasma in a space isolated from the electrode in the process room, a second power supply circuit configured to supply second power to the plasma generation unit, including, a detection unit configured to detect parameters output from the first power supply circuit, and a control unit configured to control the first power and the second power supplied from the first power supply circuit and the second power supply circuit, respectively, such that each of the parameters detected by the detection unit correspond to each of target values.

Hereinbelow, embodiments will be described with reference to the drawings.

### First Embodiment

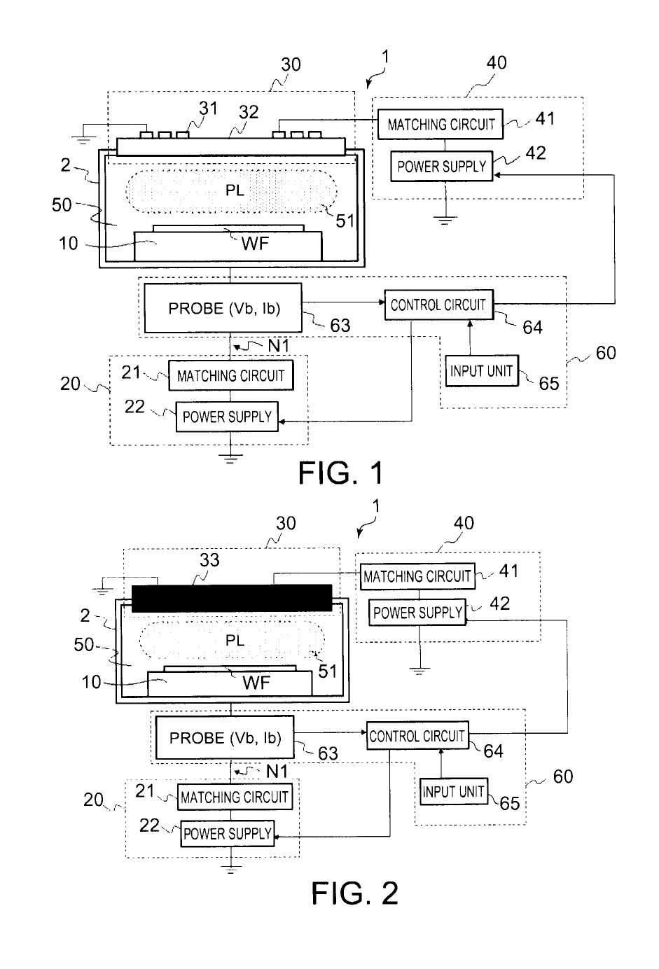

FIG. 1 is a diagram showing a configuration of a plasma processing apparatus 1 according to a first embodiment.

The plasma processing apparatus 1 includes a process room 50, an electrode 10, a first power supply circuit 20, a plasma generation unit 30, a second power supply circuit 40, and a control apparatus 60.

The process room 50 is a room in which plasma PL is generated and is surrounded by a process chamber 2. The process chamber 2 is configured such that a process gas can be supplied from a supply source (not illustrated) to the process room 50. The process chamber 2 is also configured such that the process gas after processing can be discharged from the process room 50 to an exhaust apparatus (not illustrated).

The electrode 10 is arranged on the bottom side in the process room 50 in such a manner as to be insulated from the process chamber 2 with an insulating material (not illustrated) placed in between. A substrate to be processed WF, which is a semiconductor substrate, for example, is placed on the electrode 10. The electrode 10 is formed of metal, for example.

The power supply circuit 20 generates high frequency power and supplies the high frequency power to the electrode 10. The high frequency power is power to accelerate ions such as F⁺, CF3⁺, for example, toward the electrode 10 on which the substrate to be processed WF, the ions being generated together with radicals in the process gas at the time of generating the plasma PL in the process room 50. The frequency of the high frequency power is 13.56 MHz, for example.

The power supply circuit 20 includes a high frequency power supply 22 and a matching circuit 21.

The high frequency power supply 22 generates a high frequency power Pb.

The matching circuit 21 includes a variable capacitor and a variable coil, for example. The matching circuit 21 performs impedance matching by using the variable capacitor and the variable coil so that impedances of the matching circuit 21 on a side of the high frequency power supply 22 and on a side of the electrode 10 can be equal to each other.

The plasma generation unit 30 generates the plasma PL in a space 51 away from the electrode 10 in the process room 50. Specifically, the plasma generation unit 30 includes antenna coils 31 and a dielectric wall 32. The antenna coils generate an electromagnetic wave (a high frequency magnetic field) by using the high frequency power supplied from the power supply circuit 40. The electromagnetic wave generated by the antenna coils 31 is transmitted through the dielectric wall 32 to be introduced into the space 51 in the process room 50. In the space 51 in the process room 50, electric discharge in the process gas arises, the plasma PL is generated, and the ions of F⁺ or CF3⁺, for example, are generated together with the radicals in the process gas. Note that the dielectric wall 32 also serves as an upper wall portion of the aforementioned process chamber 2.

The power supply circuit 40 generates high frequency power and supplies the high frequency power to the plasma generation unit 30. The high frequency power is power to cause the plasma generation unit 30 to generate the plasma PL in the process room 50. The frequency of the high frequency power is 13.56 MHz, for example.

The power supply circuit 40 includes a matching circuit 41 and a high frequency power supply 42.

The high frequency power supply 42 generates a high frequency power Pi and supplies a high frequency power Pi to the antenna coils 31.

The matching circuit 41 includes a variable capacitor and a variable coil, for example. The matching circuit 41 performs impedance matching by using the variable capacitor and the variable coil so that impedances of the matching circuit 41 on the high frequency power supply 42 side and on the antenna coil 31 side can be equal to each other.

The control apparatus 60 controls the plasma processing apparatus 1. Specifically, the control apparatus 60 includes an input unit 65, a probe 63 serving as a detection unit, and a control circuit 64 serving as a control unit.

The input unit 65 in the control apparatus 60 receives a setting voltage Vbset and a setting current Ibset from a user, or from a host computer or another plasma processing apparatus through a communication line. Values of the setting voltage Vbset and the setting current Ibset are predetermined as values to be shared with different plasma processing apparatuses. The input unit 65 supplies the values of the setting voltage Vbset and the setting current Ibset to the control circuit 64.

The probe 63 in the control apparatus 60 detects a voltage Vb and a current Ib in a node N1 located between the electrode 10 and the power supply circuit 20. The probe 63 supplies values of the voltage Vb and the current Ib which are thus detected, to the control circuit 69.

The control circuit 64 in the control apparatus 60 has received the value of the setting voltage Vbset from the input unit 65 and has held the value as a target value. Upon receipt of the value of the detected voltage Vb, the control circuit 64 compares the voltage Vb with the setting voltage Vbset. The control circuit 69 controls the power supplied by the power supply circuit 20 so that the voltage Vb detected by the probe 63 can be equal to the setting voltage Vbset.

Specifically, when the detected voltage Vb is higher than the setting voltage Vbset, the control circuit 64 controls the high frequency power supply 22 in the power supply circuit 20 so that power to be generated is decreased. When the detected voltage Vb is lower than the setting voltage Vbset, the control circuit 64 controls the high frequency power supply 22 in the power supply circuit 20 so that the power to be generated is increased.

The control circuit 64 in the control apparatus 60 has received the value of the setting current Ibset from the input unit 65 and has held the value as a target value. Upon receipt of the value of the detected current Ib, the control circuit 64 compares the current Ib with the setting current Ibset. The control circuit 64 controls the power supplied by the power supply circuit 40 so that the current Ib detected by the probe 63 can be equal to the setting current Ibset. Specifically, when the detected current Ib is higher than the setting current Ibset, the control circuit 64 controls the high frequency power supply 42 in the power supply circuit 40 so that power to be generated is decreased. When the detected current Ib is lower than the setting current Ibset, the control circuit 64 controls the high frequency power supply 42 in the power supply circuit 40 so that the power to be generated is increased.

In the first embodiment, an exemplary description has been given of a case where the plasma processing apparatus 1 is an inductive coupling plasma (ICP) RIE apparatus. However, the plasma processing apparatus is not limited to the ICP-RIE apparatus. For example, the plasma processing apparatus may be an electron cyclotron resonance (ECR) RIE apparatus or a dual-frequency parallel-plate (capacitively coupled) RIE apparatus. When the plasma processing apparatus 1 is the dual-frequency parallel-plate (capacitively coupled) RIE apparatus, the plasma generation unit 30 includes an electrode 33 as shown in FIG. 2, instead of the antenna coils 31 and the dielectric wall 32, the electrode 33 being arranged in such a manner as to face the electrode 10 in the process room 50. FIG. 2 is a diagram showing another configuration of the plasma processing apparatus 1 according to the first embodiment. As shown in FIG. 2, high frequency power is supplied to the electrode 10 on which the process target substrate WF, which is a semiconductor substrate, for example, is mounted, from the high frequency power supply 22 through the matching circuit 21 and the probe 63. Power is supplied to the electrode 33 to generate plasma, from the high frequency power supply 42 through the matching circuit 41. The frequencies of the high frequency powers in the power supply circuits 20 and 40 are 2 MHz and 60 MHz, for example, respectively.

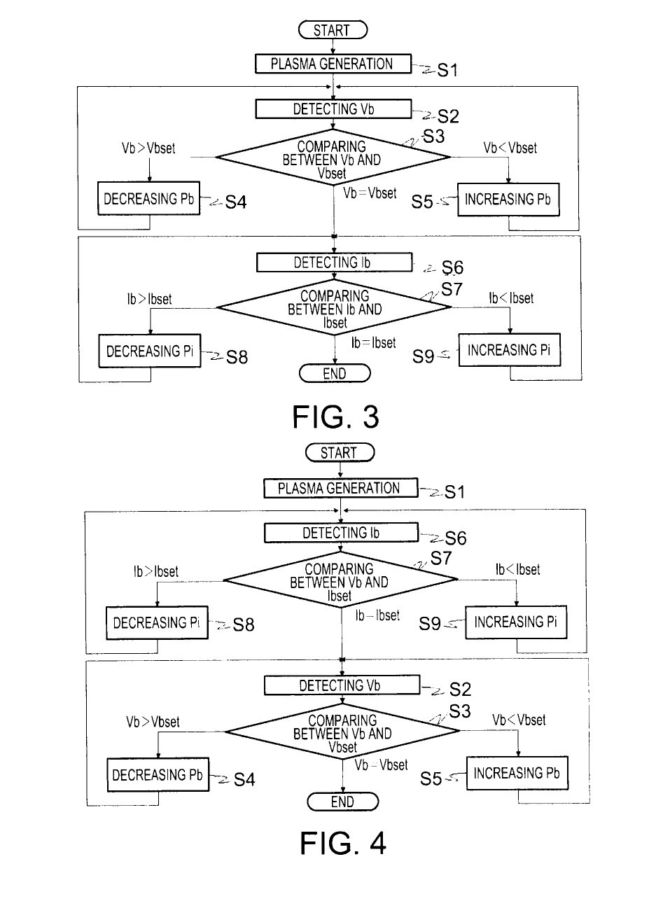

Next, actions of the control apparatus 60 will be described with reference to FIG. 3. FIG. 3 is a flowchart showing the actions of the control apparatus 60.

In Step S1, a substrate to be processed WF, which is a semiconductor substrate, for example, is placed on an electrode 10 in a process room 50. Then, a power supply circuit 20 generates high frequency power and supplies the high frequency power to the electrode 10. In addition, a power supply circuit 40 generates high frequency power and supplies the high frequency power to a plasma generation unit 30. The plasma generation unit 30 generates a plasma PL in a space 51 away from the electrode 10 in the process room 50. Specifically, a high frequency power supply 42 generates the high frequency power and supplies the high frequency power to antenna coils 31. The antenna coils 31 generate an electromagnetic wave (a high frequency magnetic field) by using the supplied high frequency power. The electromagnetic wave generated by the antenna coils 31 is transmitted through a dielectric wall 32 to be introduced into the space 51 in the process room 50. In the space 51 in the process room 50, electric discharge in a process gas arises, the plasma PL is generated, and ions of F⁺ or CF3⁺, for example, are generated together with radicals from the process gas.

In Step S2, a probe 63 detects a voltage Vb in a node N1 between the electrode 10 and the power supply circuit 20. The probe 63 supplies a value of the detected voltage (the voltage on the bias side) to a control circuit 64.

In Step S3, the control circuit 64 has received a value of a setting voltage Vbset from an input unit 65 and has held the value as a target value. Upon receipt of the value of the detected voltage Vb from the probe 63, the control circuit 64 compares the voltage Vb which is the voltage on the bias side with the setting voltage Vbset which is the target value. When the detected voltage Vb is higher than the setting voltage Vbset, the control circuit 64 moves the process to Step S4. When the detected voltage Vb is lower than the setting voltage Vbset, the control circuit 64 moves the process to Step S5. When the detected voltage Vb matches the setting voltage Vbset, the control circuit 64 moves the process to Step S6.

In Step S4, the control circuit 64 controls a high frequency power supply 22 in the power supply circuit 20 so that a power Pb to be generated is decreased.

In Step S5, the control circuit 64 controls the high frequency power supply 22 in the power supply circuit 20 so that the power Pb to be generated is increased.

In such a manner, the processes from Steps S2 to S5 are repeated as described above until the voltage Vb on the bias side matches the setting voltage Vbset. The processes are a detection action by the probe 63 and control actions by the control circuit 64 all of which are performed on the voltage Vb.

When the voltage Vb on the bias side matches the setting voltage Vbset in Step S3, the control circuit 64 moves the process to Step S6. In Step S6, the probe 63 detects a current Ib in the node N1 between the electrode 10 and the power supply circuit 20 and supplies a value of the detected current Ib to the control circuit 64.

In Step S7, the control circuit 64 has received a value of a setting current Ibset from the input unit 65 and has held the value as a target value. Upon receipt of the value of the detected current Ib from the probe 63, the control circuit 64 compares the current Ib with the setting current Ibset. When the detected current Ib is higher than the setting current Ibset, the control circuit 64 moves the process to Step S8. When the detected current Ib is lower than the setting current Ibset, the control circuit 64 moves the process to Step S9. When the detected current Ib matches the setting current Ibset, the control circuit 64 terminates the process.

In Step S8, the control circuit 64 controls the high frequency power supply 42 in the power supply circuit 40 so that a power Pi to be generated is decreased.

In Step S9, the control circuit 64 controls the high frequency power supply 42 in the power supply circuit 40 so that the power Pi to be generated is increased.

In such a manner, the processes from Steps S6 to S9 are repeated as described above until the current Ib on the bias side matches the setting current Ibset. The processes are a detection action by the probe 63 and control actions by the control circuit 64 all of which are performed on the current Ib.

When the current Ib on the bias side matches the setting current Ibset in Step S7, the control circuit 64 terminates the process.

After the current Ib on the bias side matches the setting current Ibset in Step S7, the control circuit 64 may return to Step S2 to execute the voltage-based control (Steps S2 to S5) again. In sum, the control circuit 64 may repeat the voltage-based control (Steps S2 to S5) and the current-based control (Steps S6 to S9) until both the voltage and the current reach desired values.

In the first embodiment, after performing the voltage-based control (Steps S2 to S5), the control circuit 64 performs the current-based control (Steps S6 to S9). However, as shown in FIG. 4, after performing the current-based control (Steps S6 to S9) , the control circuit 64 may perform the voltage-based control (Steps S2 to S5).

The control actions by the control circuit 64 may be performed at initial setting performed before etching, for example, which is a processing treatment. Alternatively, the control actions may be performed also in the processing treatment continuously from the initial setting for a certain time period from the initial setting. Still alternatively, the control actions may be performed all the time. In this case, it is possible to reduce variation which occurs over time from the initial setting in process dimensions or an etching amount in different plasma processing apparatuses.

The control actions by the control circuit 64 do not have to be achieved by using a circuit, for example, which is hardware, but may be achieved by using software.

According to the first embodiment, the control circuit 64 controls the power supplied by the power supply circuit 20 so that the voltage Vb detected by the probe 63 can be equal to the setting voltage Vbset. Thereby, the bias-side voltage output from the power supply circuit 20 can be made equal to the setting voltage Vbset predetermined as the value to be shared with the different plasma processing apparatuses. In addition, the control circuit 64 controls the power supplied from the power supply circuit 40 so that the current Ib detected by the probe 63 can be equal to the setting current Ibset. Thereby, the bias-side current flowing through the node N1 can be made equal to the setting current Ibset predetermined as the value to be shared with the different plasma processing apparatuses.

As the result, processing steps can be performed at an etching rate in accordance with the user requirement, that is, an etching rate corresponding to the setting voltage Vbset and the setting current Ibset. Thus, the process accuracies of the plasma processing apparatuses can be enhanced. In addition, the different plasma processing apparatuses can have both the same bias-side voltage and the same bias-side current. Thus, the variation in process dimensions or etching amount among the different plasma processing apparatuses can be reduced.

In the first embodiment, when the voltage Vb detected by the probe 63 is lower than the setting voltage Vbset, the control circuit 64 controls the high frequency power supply 22 in the power supply circuit 20 so that the power to be generated is increased. When the current Ib detected by the probe 63 is lower than the setting current Ibset, the control circuit 64 controls the high frequency power supply 42 in the power supply circuit 40 so that the power to be generated is increased. Thereby, the density of plasma generated in the process room 50 can be increased, and the ion flux (the density of ions to be accelerated) can be made closer to a target value. In another case, when the voltage Vb detected by the probe 63 is higher than the setting voltage Vbset, the control circuit 64 controls the high frequency power supply 22 in the power supply circuit 20 so that the power to be generated is decreased. When the current Ib detected by the probe 63 is higher than the setting current Ibset, the control circuit 64 controls the high frequency power supply 42 in the power supply circuit 40 so that the power to be generated is decreased. Thereby, the density of the plasma generated in the process room 50 can be decreased, and the ion flux can be made closer to the target value. In sum, while the voltage to accelerate the ions in the process room 50 is made equal to the target value, the density of the ions accelerated in the process room 50 can be made equal to the target value.

Generally, an average value of ion acceleration energy is approximately equal to amplitude of a voltage. Thus, making the voltage equal to a target value can eliminate a difference in ion energy among apparatuses. As for a current value, when an impedance of plasma or a sheath is represented by Z, current, which is voltage/|Z|, is established. Making the voltage and the current equal to the target values can eliminate a difference in |Z| among the apparatuses. A value of |Z| is determined based on a plasma state such as an electron density. The ion flux is proportional to the electron density. Accordingly, making the voltage and the current equal to the target values can eliminate the differences in ion energy and flux among apparatuses.

### Second Embodiment

Hereinbelow, a plasma processing apparatus 100 according to a second embodiment is described. Different points between the first embodiment and the second embodiment are focused in the description below. Voltage and current are detected at a probe 63 of the plasma processing apparatus 1 in the first embodiment. On the other hand, voltage and product of voltage, current and cosφ, where φ is phase difference, are detected at the probe 63 of the plasma processing apparatus 100 in the second embodiment. Hereafter, the value of product of voltage, current and cosφ is called an effective power Pe in convenience.

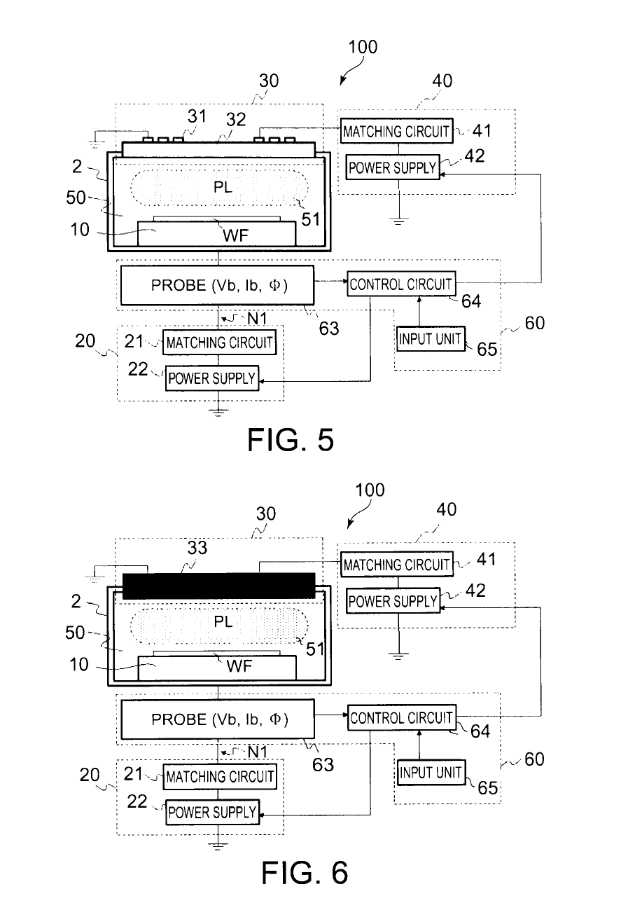

FIG. 5 is a diagram showing a configuration of a plasma processing apparatus 100 according to the second embodiment. A control apparatus 60 of the plasma processing apparatus 100 according to the second embodiment is different from that of the plasma processing apparatus 1 according to the first embodiment. A process room 50, an electrode 10, a first power supply circuit 20, a plasma generation unit 30, and a second power supply circuit 40 of the plasma processing apparatus 100 according to the second embodiment are the same as those of the plasma processing apparatus 1 according to the first embodiment. Accordingly, the explanation on the units is omitted.

The control apparatus 60 controls the plasma processing apparatus 100. Specifically, the control apparatus 60 includes an input unit 65, a probe 63 serving as a detection unit, and a control circuit 64 serving as a control unit.

The input unit 65 in the control apparatus 60 receives a setting voltage Vbset and an effective setting power Peset from a user, or from a host computer or another plasma processing apparatus through a communication line. Values of the setting voltage Vbset and the effective setting power Peset are predetermined as values to be shared with different plasma processing apparatuses. The input unit 65 supplies the values of the setting voltage Vbset and the effective setting power Peset to the control circuit 64.

The probe 63 in the control apparatus 60 detects a voltage Vb and the effective power Pe in a node N1 located between the electrode 10 and the power supply circuit 20. The probe 63 supplies values of the voltage Vb and the effective power Pe which are thus detected, to the control circuit 64.

The control circuit 64 in the control apparatus 60 has received the value of the setting voltage Vbset from the input unit 65 and has held the value as a target value. Upon receipt of the value of the detected voltage Vb, the control circuit 64 compares the voltage Vb with the setting voltage Vbset. The control circuit 69 controls the power supplied by the power supply circuit 20 so that the voltage Vb detected by the probe 63 can be equal to the setting voltage Vbset. Specifically, when the detected voltage Vb is higher than the setting voltage Vbset, the control circuit 64 controls the high frequency power supply 22 in the power supply circuit 20 so that power to be generated is decreased. When the detected voltage Vb is lower than the setting voltage Vbset, the control circuit 69 controls the high frequency power supply 22 in the power supply circuit 20 so that the power to be generated is increased.

The control circuit 64 in the control apparatus 60 has received the value of the effective setting power Peset from the input unit 65 and has held the value as a target value. Upon receipt of the value of the detected effective power Pe, the control circuit 64 compares the effective power Pe with the effective setting power Peset. The control circuit 64 controls the power supplied by the power supply circuit 40 so that the effective power Pe detected by the probe 63 can be equal to the effective setting power Peset. Specifically, when the detected effective power Pe is higher than the effective setting power Peset, the control circuit 64 controls the high frequency power supply 42 in the power supply circuit 40 so that power to be generated is decreased. When the detected effective power Pe is lower than the effective setting power Peset, the control circuit 64 controls the high frequency power supply 42 in the power supply circuit 40 so that the power to be generated is increased.

In the second embodiment, an exemplary description has been given of a case where the plasma processing apparatus 100 is an inductive coupling plasma (ICP) RIE apparatus. However, the plasma processing apparatus is not limited to the ICP-RIE apparatus. For example, the plasma processing apparatus may be an electron cyclotron resonance (ECR) RIE apparatus or a dual-frequency parallel-plate (capacitively coupled) RIE apparatus. When the plasma processing apparatus 100 is the dual-frequency parallel-plate (capacitively coupled) RIE apparatus, the plasma generation unit 30 includes an electrode 33 as shown in FIG. 6, instead of the antenna coils 31 and the dielectric wall 32, the electrode 33 being arranged in such a manner as to face the electrode 10 in the process room 50. FIG. 6 is a diagram showing another configuration of the plasma processing apparatus 100 according to the second embodiment. As shown in FIG. 6, high frequency power is supplied to the electrode 10 on which the substrate to be processed WF, which is a semiconductor substrate, for example, is mounted, from the high frequency power supply 22 through the matching circuit 21 and the probe 63. Power is supplied to the electrode 33 to generate plasma, from the high frequency power supply 42 through the matching circuit 41. The frequencies of the high frequency powers in the power supply circuits 20 and 40 are 2 MHz and 60 MHz, for example, respectively.

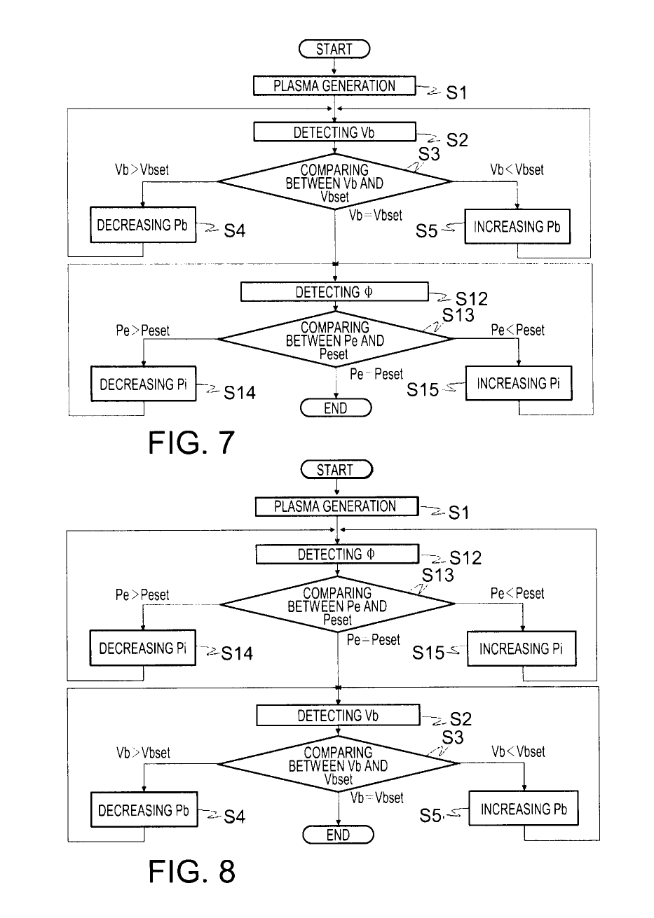

Next, actions of the control apparatus 60 will be described with reference to FIG. 7. FIG. 7 is a flowchart showing the actions of the control apparatus 60.

Processes from Steps S1 to S5 described in FIG. 7 are the same as Steps S1 to S5 described in FIG. 3 according to the first embodiment. Processes from Steps S2 to S5 are repeated until the voltage Vb on the bias side matches the setting voltage Vbset. The processes are a detection action by the probe 63 and control actions by the control circuit 64 all of which are performed on the voltage Vb.

When the voltage Vb on the bias side matches the setting voltage Vbset in Step S3, the control circuit 64 moves the process to Step S12. In Step S12, the probe 63 detects the effective power Pe in the node N1 between the electrode 10 and the power supply circuit 20 and supplies a value of the detected the effective power Pe to the control circuit 64.

In Step S13, the control circuit 64 has received a value of a effective setting power Peset from the input unit 65 and has held the value as a target value. Upon receipt of the value of the detected effective power Pe from the probe 63, the control circuit 64 compares the effective power Pe with the effective setting power Peset. When the detected effective power Pe is higher than the effective setting power Peset, the control circuit 64 moves the process to Step S14. When the detected effective power Pe is lower than the effective setting power Peset, the control circuit 64 moves the process to Step S15. When the detected effective power Pe matches the effective setting power Peset, the control circuit 64 terminates the process.

In Step S14, the control circuit 64 controls the high frequency power supply 42 in the power supply circuit 40 so that a power Pi to be generated is decreased.

In Step S15, the control circuit 64 controls the high frequency power supply 42 in the power supply circuit 40 so that the power Pi to be generated is increased.

Processes from Steps S12 to S15 are repeated as described above until the effective power Pe on the bias side matches the effective setting power Peset. The processes are a detection action by the probe 63 and control actions by the control circuit 64 all of which are performed on the effective power Pe.

When the effective power Pe on the bias side matches the effective setting power Peset in Step S13, the control circuit 64 terminates the process.

After the effective power Pe on the bias side matches the effective setting power Peset in Step S13, the control circuit 64 may return to Step S2 to execute the voltage-based control (Steps S2 to S5) again. In sum, the control circuit 64 may repeat the voltage-based control (Steps S2 to S5) and the current-based control (Steps S12 to S15) until both the voltage and the current reach desired values.

In the second embodiment, after performing the voltage-based control (Steps S2 to S5) , the control circuit 64 performs the effective power-based control (Steps S12 to S15). However, as shown in FIG. 8, after performing the current-based control (Steps S12 to S15), the control circuit 64 may perform the voltage-based control (Steps S2 to S5).

The control actions by the control circuit 64 may be performed at initial setting performed before etching, for example, which is a processing treatment. Alternatively, the control actions may be performed also in the processing treatment continuously from the initial setting for a certain time period from the initial setting. Still alternatively, the control actions may be performed all the time. In this case, it is possible to reduce variation which occurs over time from the initial setting in process dimensions or an etching amount in different plasma processing apparatuses.

The control actions by the control circuit 64 do not have to be achieved by using a circuit, for example, which is hardware, but may be achieved by using software.

According to the second embodiment, the control circuit 64 controls the power supplied by the power supply circuit 20 so that the voltage Vb detected by the probe 63 can be equal to the setting voltage Vbset. Thereby, the bias-side voltage output from the power supply circuit 20 can be made equal to the setting voltage Vbset predetermined as the value to be shared with the different plasma processing apparatuses. In addition, the control circuit 64 controls the power supplied from the power supply circuit 40 so that the effective power Pe detected by the probe 63 can be equal to the effective setting power Peset. Thereby, the effective power Pe in the node N1 can be made equal to the effective setting power Peset predetermined as the value to be shared with the different plasma processing apparatuses.

As the result, processing steps can be performed at an etching rate in accordance with the user requirement, that is, an etching rate corresponding to the setting voltage Vbset and the effective setting power Peset. Thus, the process accuracies of the plasma processing apparatuses can be enhanced. In addition, the different plasma processing apparatuses can have both the same bias-side voltage and the same bias-side effective power. Thus, the variation in process dimensions or etching amount among the different plasma processing apparatuses can be reduced.

In the second embodiment, when the voltage Vb detected by the probe 63 is lower than the setting voltage Vbset, the control circuit 64 controls the high frequency power supply 22 in the power supply circuit 20 so that the power to be generated is increased. When the effective power Pe detected by the probe 63 is lower than the effective setting power Peset, the control circuit 64 controls the high frequency power supply 42 in the power supply circuit 40 so that the power to be generated is increased. Thereby, the density of plasma generated in the process room 50 can be increased, and the ion flux (the density of ions to be accelerated) can be made closer to a target value. In another case, when the voltage Vb detected by the probe 63 is higher than the setting voltage Vbset, the control circuit 64 controls the high frequency power supply 22 in the power supply circuit 20 so that the power to be generated is decreased. When the effective power Pe detected by the probe 63 is higher than the effective setting power Peset, the control circuit 64 controls the high frequency power supply 42 in the power supply circuit 40 so that the power to be generated is decreased. Thereby, the density of the plasma generated in the process room 50 can be decreased, and the ion flux can be made closer to the target value. In sum, while the voltage to accelerate the ions in the process room 50 is made equal to the target value, the density of the ions accelerated in the process room 50 can be made equal to the target value.

Generally, an average value of ion acceleration energy is approximately equal to amplitude of a voltage. Thus, making the voltage equal to a target value can eliminate a difference in ion energy among apparatuses. As for an effective power, which is a value of product of voltage, current and cosφ, is equal to a power consumed at an electrode on which a substrate to be processed is disposed. The power consumed at the electrode is used as a power accelerating ions and electrons due to voltage at the electrode. The power is determined by ion density, electron density and acceleration energy. Controlling the voltage to a target value is equal to controlling the acceleration energy to a target value. When the power is controlled to the target value, ion density and electron density are controlled to be set as constant values. The ion flux is proportional to the electron density. Accordingly, making the voltage and effective power, which is a value of product of voltage, current and cosφ, equal to the target values can eliminate the differences in ion energy and flux among apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus configured to control a plasma processing apparatus,
the plasma processing apparatus comprising an electrode on which a substrate to be processed is disposed, in a process room, a first power supply circuit configured to supply first power to the electrode, a plasma generation unit configured to generate plasma in a space isolated from the electrode in the process room, a second power supply circuit configured to supply second power to the plasma generation unit, comprising:
a detection unit configured to detect parameters output from the first power supply circuit; and
a control unit configured to control the first power and the second power supplied from the first power supply circuit and the second power supply circuit, respectively, such that each of the parameters detected by the detection unit corresponds to each of target values.

2. The control apparatus of claim 1, wherein
the parameters detected from the detection unit include voltage and current.

3. The control apparatus of claim 2, wherein
the control unit decreases the first power supplied from the first power supply circuit when the voltage detected by the detection unit is larger than the target value and increases the first power supplied from the first power supply circuit when the voltage detected by the detection unit smaller than the target value, and
the control unit decreases the second power supplied from the second power supply circuit when the current detected by the detection unit is larger than the target value and increases the second power supplied from the second power supply circuit when the current detected by the detection unit smaller than the target value.

4. The control apparatus of claim 1, wherein
the parameters detected from the detection unit include voltage and a value of product of voltage, current and cosφ where φ is phase difference between voltage and current.

5. The control apparatus of claim 4, wherein
the control unit decreases the first power supplied from the first power supply circuit when the voltage detected by the detection unit is larger than the target value and increases the first power supplied from the first power supply circuit when the voltage detected by the detection unit smaller than the target value, and
the control unit decreases the second power supplied from the second power supply circuit when the value of product of voltage, the current and cosφ detected by the detection unit is larger than the target value and increases the second power supplied from the second power supply circuit when the value of product of voltage, current and cosφ detected by the detection unit smaller than the target value.

6. A plasma processing apparatus, comprising:
an electrode on which a substrate to be processed is disposed in a process room;
a first power supply circuit configured to supply first power to the electrode;
a plasma generation unit configured to generate plasma in a space isolated from the electrode in the process room, a second power supply circuit configured to supply second power to the plasma generation unit;
a detection unit configured to detect parameters output from the first power supply circuit; and
a control unit configured to control the first power and the second power supplied from the first power supply circuit and second power supply circuit, respectively, such that each of the parameters detected by the detection unit corresponds to each of target values, respectively.

7. A method for controlling a control apparatus configured to control a plasma processing apparatus,
the plasma processing apparatus comprising an electrode on which a substrate to be processed is disposed, in a process room, a first power supply circuit configured to supply first power to the electrode, a plasma generation unit configured to generate a space isolated from the electrode in the process room, and a second power supply circuit configured to supply a second power to the plasma generation unit, comprising:
detecting parameters output from the first power supply circuit; and
controlling the first power and the second power supplied from the first power supply circuit and the second power supply circuit, respectively, such that each of the parameters detected by the detection unit corresponds to each of the target values, respectively.
